(19) United States
(12) Patent Application Publication
(10) Pub. No.: US 2018/0111069 A1
(43) Pub. Date: Apr. 26, 2018

(54) BALLAST WATER TREATMENT DEVICE

(71) Applicant: MIURA CO., LTD., Matsuyama-shi (JP)

(72) Inventor: YASUHIKO SAITO, Matsuyama-shi (JP)

(73) Assignee: MIURA CO., LTD., Matsuyama-shi (JP)

(21) Appl. No.: 15/382,361

(22) Filed: Dec. 16, 2016

(30) Foreign Application Priority Data
Oct. 21, 2016 (JP) 2016-207233

(51) Int. Cl. B01D 33/50; B01D 35/02; B01D 33/06; C02F 1/00

(52) U.S. Cl. CPC B01D 33/50; B01D 35/02; C02F 2103/008; C02F 1/004; B01D 33/06

(57) ABSTRACT

Provided is a ballast water treatment device that can discharge ballast water stored in a casing quickly and in a preferable manner. The ballast water treatment device 1 is provided with: a casing 10; a filter 20 which is disposed in the casing 10 and which filters ballast water; an introduction portion 14 which introduces ballast water to a primary side of the filter 20; a first discharge portion in the casing 10 for discharging the ballast water from the primary side of the filter 20; and a second discharge portion 131 which is disposed at a lower portion of the casing 10 at a secondary side of the filter 20, and which discharges the ballast water from the secondary side of the filter 20.

### BACKGROUND

### 1. Technical Field

The present invention relates to a ballast water treatment device provided with a filter for filtering ballast water.

### 2. Related Art

A vessel such as a tanker usually stores water called ballast water in a ballast tank disposed on the vessel in order to balance the vessel under way while traveling toward another destination after unloading freight such as crude petroleum. Ballast water is normally charged at an unloading port and discharged at a loading port. Therefore, if these ports are located at different places, microorganisms such as plankton and bacteria in the ballast water may come to travel all over the world. Thus, ballast water is discharged at a loading port in a sea area different from that of an unloading port, and microorganisms in another sea area are released at the loading port and may destroy the ecosystem in the sea area.

In order to decrease the amount of microorganisms contained in the ballast water, a ballast water treatment device has been proposed which is provided with a casing for storing ballast water, and a filter which is disposed in the casing and which filters the ballast water (see JP-A2014-227107, for example).

### SUMMARY

The filter of the ballast water treatment device is required to provide high levels of microorganism removal performance. Accordingly, the filter uses a filtering body of, e.g., wire netting with an extremely small mesh opening. Because the filter made of the filtering body with an extremely small mesh opening easily becomes clogged, regular rinsing is required.

Accordingly, after the end of operation of the ballast water treatment device, the ballast water stored in the casing is discharged, and then rinsing is performed whereby the filter is sprayed with rinsing water to remove foreign matter in a state in which no ballast water is present in the casing. When such rinsing is performed, in order to reduce the time for rinsing, it is required to discharge the ballast water stored in the casing quickly. In addition, in order to rinse the filter in a preferable manner, it is required to perform the discharging so that no ballast water remains in the casing.

Accordingly, an object of the present invention is to provide a ballast water treatment device with which the ballast water stored in the casing can be discharged quickly and in a preferable manner.

The present invention relates to a ballast water treatment device including a casing; a filter disposed in the casing to filter ballast water; an introduction portion for introducing the ballast water to a primary side of the filter; a first discharge portion in the casing for discharging the ballast water from the primary side of the filter; and a second discharge portion disposed at a lower portion of the casing at a secondary side of the filter to discharge the ballast water from the secondary side of the filter.

According to the ballast water treatment device of the present invention, ballast water stored in the casing can be discharged quickly and in a preferable manner.

### BRIEF DESCRIPTION OF DRAWINGS

FIG. 1 is a diagram illustrating the configuration of a ballast water treatment device according to a first embodiment of the present invention; and

FIG. 2 is a diagram illustrating the configuration of a ballast water treatment device according to a second embodiment of the present invention.

### DETAILED DESCRIPTION

In the following, preferred embodiments of the ballast water treatment device according to the present invention will be described with reference to the drawings.

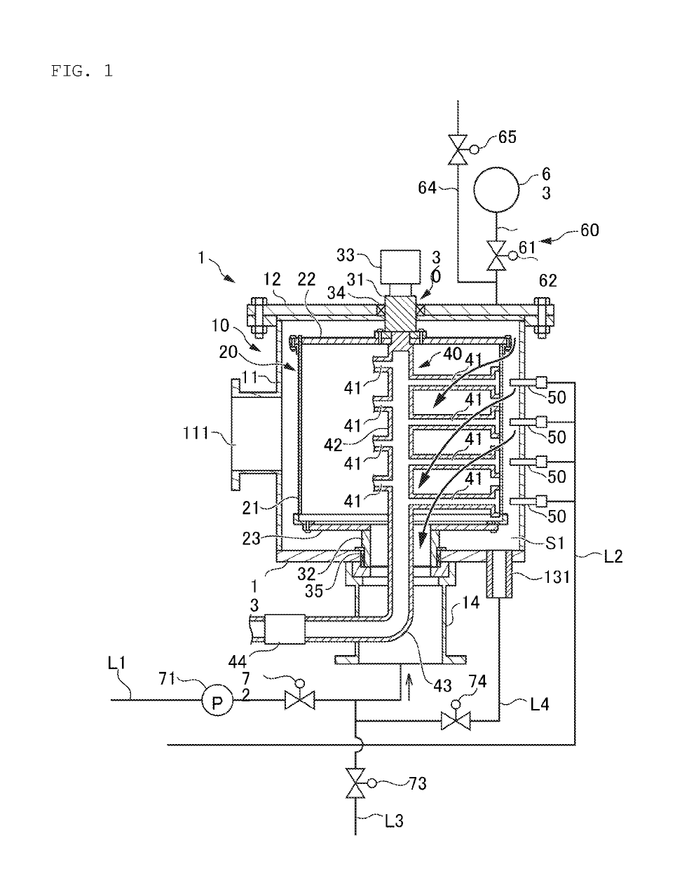

As illustrated in FIG. 1, the ballast water treatment device 1 according to the first embodiment is provided with a casing 10; a filter 20 disposed in the casing 10; a filter rotation unit 30; an introduction portion 14 for introducing ballast water into the casing 10; a backwash mechanism 40 for backwashing the filter 20; injection nozzles 50 for injecting rinsing water onto the filter 20; a compressed gas supply unit 60 for supplying compressed gas into the casing 10; an introduction line L1 for introducing ballast water into the casing 10; a rinsing water line L2; a discharge line L3 for discharging the ballast water stored in the casing 10 from the primary side of the filter 20, the discharge line L3 constituting a part of a first discharge portion; a second discharge portion 131 for discharging, from the secondary side of the filter 20, the ballast water stored in the casing 10; and a line L4 through which the ballast water discharged from the second discharge portion 131 flows.

In the present specification, the “line” is a general term referring to a path which enables fluid flow, and may include a flow passageway, a route, a conduit and the like.

The casing 10 stores ballast water. The casing 10 is provided with a cylindrical body portion 11 having an open upper end and an open lower end; an upper-lid portion 12 which seals the upper end of the body portion 11; and a lower-lid portion 13 which seals the lower end of the body portion 11.

A peripheral surface of the body portion 11 is provided with a flow outlet 111 through which the ballast water stored in the casing 10 and filtered by the filter 20 as will be described below flows out.

The filter 20 is provided with a cylindrical filter body 21 with an open upper end and an open lower end; an upper closing portion 22 which seals the upper end of the filter body 21; and a lower closing portion 23 which seals the lower end of the filter body 21.

The filter 20 (filter body 21) is formed in the shape of a cylinder smaller than the casing 10, and is disposed in the casing 10 coaxially with the casing 10. Accordingly, between the casing 10 and the filter 20, a ballast water outflow space S1 is formed.

The filter rotation unit 30 rotates the filter 20 disposed in the casing 10 about a central axis. The filter rotation unit 30 includes an upper rotating shaft member 31, a lower rotating shaft member 32, and a motor 33 for rotating the upper rotating shaft member 31.

The upper rotating shaft member 31 is disposed at a position corresponding to the central axis of the filter 20 in the upper closing portion 22 of the filter 20 and protrudes upward. The lower rotating shaft member 32 is disposed at a position corresponding to the central axis of the filter 20 in the lower closing portion 23 of the filter 20 and protrudes downward.

The upper rotating shaft member 31 penetrates through the upper-lid portion 12 of the casing 10, and is supported by the upper-lid portion 12 via a sealed bearing member 34 in a freely rotatable and liquid-tight manner. The lower rotating shaft member 32 penetrates through the lower-lid portion 13 of the casing 10, and is supported by the lower-lid portion 13 via a sealed bearing member 35 in a freely rotatable and liquid-tight manner. The lower rotating shaft member 32 is a pipe-shaped member in communication with the inside of the filter 20. The lower rotating shaft member 32 protrudes from the lower-lid portion 13 of the casing 10 to the outside of the casing 10.

The introduction portion 14 is formed of a pipe-shaped member, and has one end (upper end) connected to the lower-lid portion 13 so as to cover the lower end side of the lower rotating shaft member 32. The other end (lower end) of the introduction portion 14 is connected to the introduction line L1, which will be described later. The other end of the introduction portion 14 introduces the ballast water supplied via the introduction line L1 into the primary side of the filter 20 in the casing 10.

The backwash mechanism 40 is provided with suction nozzles 41, a collection pipe 42, a discharge pipe 43, and an open/close valve 44 disposed on the discharge pipe 43.

The suction nozzles 41 are disposed on the primary side (inside) of the filter 20, with the tip-end side of the suction nozzles 41 opened toward the surface (inner peripheral surface) on the primary side of the filter 20. According to the present embodiment, the suction nozzles 41 are disposed so as to extend in a direction perpendicular to the direction in which the central axis of the filter 20 extends. A plurality of suction nozzles 41 is disposed at predetermined intervals in the direction in which the central axis of the filter 20 extends (vertical direction). Through the suction nozzles 41, the ballast water that flows from the secondary side toward the primary side of the filter 20 and the foreign matter that has been peeled by the ballast water from the inner peripheral surface of the filter 20 flow.

The collection pipe 42 is disposed at a position aligned with the central axis of the filter 20, and has a closed upper end and an open lower end. The upper end of the collection pipe 42 is inserted into a hole provided at the center of the upper closing portion 22 of the filter 20 and supported therein. To the collection pipe 42, the ballast water and foreign matter that have flowed through the suction nozzles 41 flow collectively.

The discharge pipe 43 has an upper end connected to the lower end of the collection pipe 42, and extends downward through the lower rotating shaft member 32 so as not to interfere with the rotation of the filter 20. The lower end side of the discharge pipe 43 is bent and extends through the peripheral surface of the introduction portion 14. The discharge pipe 43 discharges the ballast water and foreign matter that have flowed through the collection pipe 42.

The open/close valve 44 is disposed on the discharge pipe 43 on the secondary side with respect to the portion thereof penetrating through the introduction portion 14. The open/close valve 44 opens and closes the discharge pipe 43.

The injection nozzles 50 are disposed on the secondary side of the filter 20, and have the tip-end portions thereof opened toward the surface on the secondary side of the filter 20 (outer peripheral surface). According to the present embodiment, a plurality of injection nozzles 50 is disposed at predetermined intervals in a direction in which the central axis of the filter 20 extends (vertical direction). The injection nozzles 50 are connected to the rinsing water line L2, which will be described later, and inject the rinsing water supplied via the rinsing water line L2 onto the surface on the secondary side of the filter 20.

The compressed gas supply unit 60 is provided with a compressed gas supply source 63, such as a compressor; a compressed gas supply line 61; and a compressed gas supply valve 62. The compressed gas supply line 61 is connected to the upper-lid portion 12 of the casing 10, and supplies compressed gas between the filter 20 and the casing 10 (the secondary side of the filter 20 in the casing 10). According to the present embodiment, compressed air is used as the compressed gas.

In addition, according to the first embodiment, to the compressed gas supply unit 60, an air-vent line 64 is connected, and an air-vent valve 65 is disposed on the air-vent line 64. The air-vent line 64 has one end connected to the compressed gas supply line 61 on the casing 10 side with respect to the compressed gas supply valve 62, and the other end opened. The air-vent valve 65 opens and closes the air-vent line 64.

The introduction line L1 introduces the ballast water (sea water) into the casing 10. The introduction line L1 has the tip-end portion connected to the introduction portion 14. On the introduction line L1, a pump 71 and an open/close valve 72 are disposed.

The rinsing water line L2 has the tip-end side connected to the injection nozzles 50 to supply rinsing water to the injection nozzles 50. The proximal end side of the rinsing water line L2 is connected to a rinsing water supply source (not illustrated).

The discharge line L3 has its primary-side end connected to the introduction line L1 on the secondary side with respect to the open/close valve 72. The discharge line L3 is used when the ballast water stored in the casing 10 is discharged via the primary side of the filter 20. Specifically, the ballast water stored in the casing 10 is discharged via the lower rotating shaft member 32, the introduction portion 14, a part of the introduction line L1, and the discharge line L3 constituting the first discharge portion. On the discharge line L3, an open/close valve 73 is disposed.

The second discharge portion 131 is disposed at the lower-lid portion 13 of the casing 10 at the secondary side of the filter 20. The second discharge portion 131 is configured from a pipe-shaped member connected to the lower-lid portion 13. The second discharge portion 131 is used when the ballast water stored in the casing 10 is discharged from the secondary side of the filter 20.

The line L4 has its primary-side end connected to the second discharge portion 131, with the secondary side end thereof connected to the primary side (introduction line L1 side) of the discharge line L3 with respect to the open/close valve 73. On the line L4, an open/close valve 74 is disposed.

In the ballast water treatment device 1, when the ballast water is to be filtered, the open/close valve 72 on the introduction line L1 is opened, and the pump 71 is driven. In addition, the open/close valve 74 on the line L4 is closed. As the filter 20 is rotated by the filter rotation unit 30, the ballast water supplied via the introduction line L1 into the introduction portion 14 passes through the lower rotating shaft member 32 and is introduced into the primary side (inside) of the filter 20 in the casing 10. The ballast water is then filtered by the filter 20, and flows out of the flow outlet 111. The ballast water that has flowed out of the flow outlet 111 is stored in a ballast tank (not illustrated).

In this state, the open/close valve 44 of the backwash mechanism 40 is opened, whereby the insides of the suction nozzles 41, the collection pipe 42, and the discharge pipe 43 become negative pressure with respect to the inside of the casing 10. Accordingly, some of the ballast water that has been filtered from the primary side to the secondary side (ballast water outflow space S1 side) of the filter 20 again flows from the secondary side of the filter 20 to the primary side. The ballast water is then suctioned out of the suction nozzles 41 while peeling the foreign matter attached to the inner peripheral surface of the filter 20. The ballast water and peeled foreign matter that have flowed through the suction nozzles 41 pass through the collection pipe 42 and the discharge pipe 43 and are discharged. In this way, the filter 20 is backwashed and the foreign matter attached to the primary side of the filter 20 is removed.

When the ballast water filtering process is performed, the compressed gas supply valve 62 and the air-vent valve 65 of the compressed gas supply unit 60 are closed.

Meanwhile, after the end of operation of the ballast water treatment device 1, or when it is desired to rinse the filter 20 more strongly, the ballast water stored in the casing 10 is discharged. Then, in a state in which no water is present in the casing 10, the filter 20 is sprayed with rinsing water to remove foreign matter by rinsing. In this case, initially the open/close valve 72 of the introduction line L1 is closed, and the pump 71 is stopped. In addition, the open/close valve 44 of the backwash mechanism 40 is closed. Then, the open/close valve 73 of the discharge line L3 and the open/close valve 74 of the line L4 are opened. In this state, the compressed gas supply valve 62 of the compressed gas supply unit 60 is opened.

As a result, the compressed gas supplied from the compressed gas supply source is supplied into the casing 10, whereby the inside of the casing 10 is pressurized. Accordingly, the ballast water stored in the casing 10 is discharged via the lower rotating shaft member 32, the introduction portion 14, the introduction line L1, and the discharge line L3 (first discharge portion), while being also discharged via the second discharge portion 131, the line L4, and the discharge line L3. Thus, the ballast water can be discharged via the two locations of the first discharge portion and the second discharge portion 131. Compared with the typical drainage by the opening to the atmosphere, drainage can be performed in a short time. In addition, even in a situation where the introduction line L1 or the filter 20 is clogged, which has been a drainage inhibiting factor, drainage can be easily performed by avoiding the influence of such factor. As a result, the rinsing time for the filter 20 can be decreased, and rinsing can be performed without rinsing failure or rinsing variations.

Because the second discharge portion 131 is disposed at a bottom portion of the casing 10 (lower-lid portion 13), the ballast water in the casing 10 can be discharged in a more preferable manner, whereby the filter 20 can be completely exposed to the air. In this way, the rinsing time for the filter 20 can be further reduced, and even better rinsing without rinsing failure of the filter 20 or rinsing variations can be performed.

The ballast water treatment device 1 according to the first embodiment described above provides the following effects.

(1) In the ballast water treatment device 1, when the filter 20 has become clogged, the ballast water in the casing 10 is discharged and then the filter 20 is rinsed to eliminate the clogging. For this purpose, the ballast water treatment device 1 is provided with the first discharge portion (the lower rotating shaft member 32, the introduction portion 14, the introduction line L1, and the discharge line L3) in the casing 10 for discharging the ballast water from the primary side of the filter 20, and the second discharge portion 131 provided at the lower portion of the casing 10 at the secondary side of the filter 20. In this way, the ballast water stored in the casing 10 can be quickly discharged via the first discharge portion and the second discharge portion 131.
(2) The ballast water treatment device 1 is provided with the compressed gas supply unit 60 for supplying compressed gas into the casing 10. In this way, by supplying compressed gas into the casing 10, the inside of the casing 10 can be pressurized, whereby the ballast water stored in the casing 10 can be more quickly discharged via the first discharge portion and the second discharge portion 131.

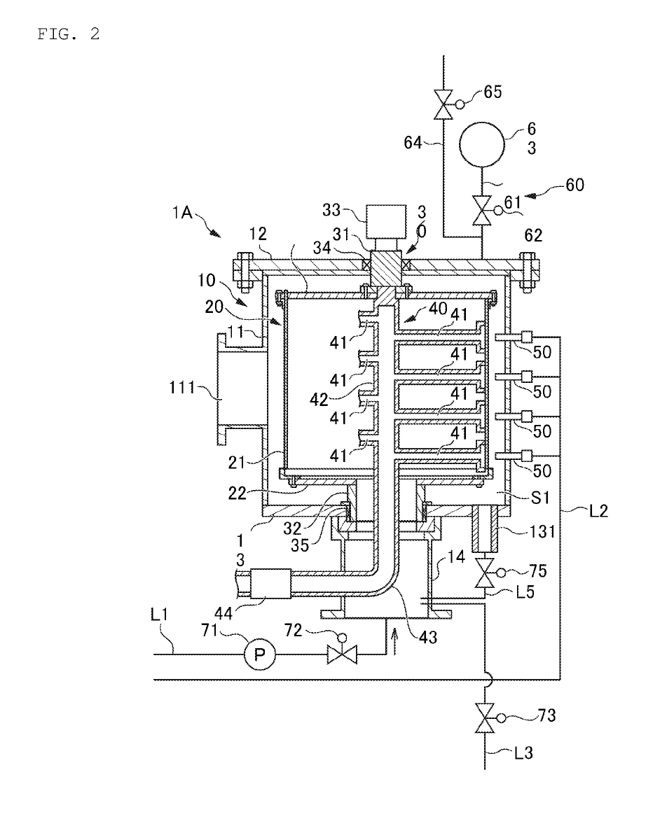

A ballast water treatment device 1A according to a second embodiment of the present invention will be described with reference to FIG. 2. The ballast water treatment device 1A according to the second embodiment differs from the first embodiment in the configuration of the discharge line L3 and the configuration of a communication line L5, which corresponds to the communication unit in the claim.

In the second embodiment, the discharge line L3 has the primary-side end connected to the introduction portion 14. That is, in the second embodiment, the ballast water stored in the casing 10 is discharged via the lower rotating shaft member 32, the introduction portion 14, and the discharge line L3 as the first discharge portion. On the discharge line L3, the open/close valve 73 is disposed.

In the present embodiment, the discharge line L3 has a flow passageway cross sectional area smaller than a flow passageway cross sectional area of the introduction portion 14.

The communication line L5, as opposed to the line L4 according to the first embodiment, provides communication between the primary side and the secondary side of the filter 20. In the second embodiment, the communication line L5, by connecting the second discharge portion 131 and the introduction portion 14, provides communication between a space on the primary side and a space on the secondary side of the filter 20 in the casing 10. On the communication line L5, an open/close valve 75 is disposed. In the second embodiment, a connection portion of the communication line L5 and the introduction portion 14 is disposed above (toward the casing 10) a connection portion of the discharge line L3 and the introduction portion 14. The communication line L5 has a flow passageway cross sectional area smaller than a flow passageway cross sectional area of the introduction portion 14 and a flow passageway cross sectional area of the discharge line L3.

In the second embodiment, the communication line L5 provides communication between the primary side and the secondary side of the filter 20 so that the compressed gas supplied from the compressed gas supply unit 60 to the secondary side of the filter 20 can pass through the second discharge portion 131 and the introduction portion 14 but does not flow to the discharge line L3 side, while instead flowing toward the top on the primary side of the filter 20.

Specifically, when ballast water is present on the primary side of the filter 20, the compressed gas supplied from the compressed gas supply unit 60 to the secondary side of the filter 20 passes through the second discharge portion 131 and the communication line L5 and reaches the introduction portion 14. However, the compressed gas does not flow toward the discharge line L3 because of the difference in specific gravity between water and gas, and instead the compressed gas flows toward the top on the primary side of the filter 20.

The compressed gas that has been supplied from the compressed gas supply unit 60 to the secondary side of the filter 20 and that has flowed to the primary side via the filter 20 pushes the ballast water on the primary side, and then passes through the introduction portion 14 and flows toward the discharge line L3. In this case, the ballast water on the secondary side of the filter 20 is discharged, after the water on the primary side of the filter 20 is discharged or simultaneously with the discharge, out of the discharge line L3 via the second discharge portion 131, the communication line L5, and the introduction portion 14 due to the difference in specific gravity or pressure between water and gas.

In particular, according to the present embodiment, by connecting the communication line L5 to the introduction portion 14 disposed at a lower part near the casing 10, the compressed gas that flows through the communication line L5 can be guided to the inside of the casing 10 in a preferable manner.

According to the ballast water treatment device 1A of the second embodiment, when the ballast water is filtered, filtering is performed similarly to the first embodiment with the open/close valve 75 on the communication line L5 closed.

After the end of operation of the ballast water treatment device 1A, or when the filter 20 is desired to be more strongly rinsed, for example, the open/close valve 75 on the communication line L5 is opened, and the compressed gas supply valve 62 on the compressed gas supply unit 60 is opened as in the first embodiment.

Then, the compressed gas supplied from the compressed gas supply source is supplied to the inside of the casing 10, whereby the inside of the casing 10 is pressurized. In this way, the ballast water stored in the casing 10 is discharged via the lower rotating shaft member 32, the introduction portion 14, the introduction line L1, and the discharge line L3 (the first discharge portion), while being discharged via the second discharge portion 131, the introduction portion 14, and the discharge line L3. Accordingly, the ballast water is discharged from the two locations of the primary side and the secondary side of the filter 20, so that the ballast water stored in the casing 10 can be quickly discharged.

If, due to the clogging of the filter 20, the flow of the compressed gas between the secondary side and the primary side of the filter 20 via the filter 20 is not smooth, the ballast water that is present on the side to which the compressed gas in the casing 10 is supplied (in the present embodiment, the secondary side of the filter 20) may be discharged with priority. As a result, the ballast water may remain on the side to which the compressed gas in the casing 10 is not supplied (in the present embodiment, the primary side of the filter 20), resulting in a failure to discharge the ballast water quickly.

Accordingly, in the second embodiment, the ballast water treatment device 1A is provided with the communication line L5 providing communication between the primary side and the secondary side of the filter 20. In this way, even when the flow of compressed gas via the filter 20 is inhibited by the clogging of the filter 20, the compressed gas supplied to the inside of the casing 10 can be supplied to both the primary side and the secondary side of the filter 20 in the casing via the communication line L5. Accordingly, the space on the primary side and the space on the secondary side of the filter 20 can be similarly pressurized, whereby the ballast water present in both the primary side and the secondary side of the filter 20 can be discharged in a preferable manner. That is, according to the second embodiment, regardless of the state of clogging of the filter 20 (i.e., the degree of contamination of the filter 20), the ballast water present on both the primary side and the secondary side of the filter 20 can be discharged in a preferable manner. In contrast, if the communication line L5 is not provided, in a small clogging state of the filter 20, the ballast water on the primary side of the filter 20 may be discharged in a preferable manner, and the water level on the primary side may be decreased. However, as the clogging of the filter 20 proceeds, the ballast water discharge capability on the primary side will decrease, and the level of the ballast water that remains on the primary side will be increased.

After the ballast water is discharged from the inside of the casing 10, rinsing water is injected from the injection nozzles 50 onto the surface on the secondary side of the filter 20 while the filter 20 is being rotated by the filter rotation unit 30. Thus, the filter 20 is rinsed.

The ballast water treatment device 1A according to the second embodiment described above provides the following effects, in addition to the effects similar to those of the first embodiment.

(3) The ballast water treatment device 1A is provided with the communication line L5 as a communication unit providing communication between the primary side and the secondary side of the filter 20. In this way, even if the compressed gas flow via the filter 20 is inhibited by the clogging of the filter 20, the compressed gas supplied to the inside of the casing 10 can be supplied to both the primary side and the secondary side of the filter 20 in the casing evenly via the communication line L5. Accordingly, the space on the primary side and the space on the secondary side of the filter 20 can be similarly pressurized, whereby the ballast water present on both the primary side and the secondary side of the filter 20 can be discharged in a preferable manner.
(4) The compressed gas supply unit 60 is caused to supply compressed gas between the filter 20 and the casing 10 (the space on the secondary side of the filter 20). In this case, the compressed gas is supplied to the secondary side of the filter 20. Accordingly, if the compressed gas flow between the secondary side and the primary side of the filter 20 is not smooth due to the clogging of the filter 20, the ballast water present on the secondary side of the filter 20 would be discharged with priority via the second discharge portion 131, resulting in a state in which the ballast water remains on the primary side of the filter 20. However, according to the present embodiment, the compressed gas supplied to the secondary side of the filter 20 in the casing 10 can be supplied to the primary side of the filter 20 in the casing 10 via the communication line L5. Accordingly, the space on the primary side of the filter 20 can be pressurized similarly to the space on the secondary side of the filter 20, whereby the ballast water remaining on the primary side of the filter 20 can be discharged in a preferable manner. In addition, by supplying the compressed gas discharged from the second discharge portion 131 to the space on the primary side of the filter 20 without discharging via the discharge line L3, the compressed gas can be effectively utilized. Accordingly, the ballast water can be discharged in a preferable manner without increasing the amount of consumption of compressed gas.
(5) The communication line L5 connects the second discharge portion 131 and the introduction portion 14. In this way, the compressed gas supplied from the secondary side of the filter 20 via the second discharge portion 131 can be supplied to the primary side of the filter 20 in a preferable manner. Accordingly, the ballast water discharge promoting effect can be obtained in a more preferable manner.
(6) The cross sectional flow passageway area of the introduction portion 14 is made greater than the cross sectional flow passageway area of the discharge line L3. In this way, the compressed gas introduced via the communication line L5 to the introduction portion 14 can be guided toward the casing 10 with higher priority.

The preferred embodiments of the ballast water treatment device according to the present invention have been described. However, the present invention is not limited to the embodiments, and may be implemented in various modes.

For example, in the embodiments, the filter 20 is a tubular filter which filters the ballast water flowing therein and which causes the ballast water to flow to the outside. However, this is not a limitation. For example, the filter may be a tubular filter by which the ballast water is caused to flow in from the outside and then flow out from the inside. The filter may not be a tubular filter.

In the embodiments, the ballast water treatment device 1 includes the filter 20 which rotates. However, this is not a limitation. For example, the ballast water treatment device may be provided with a filter which is fixed to the casing (i.e., an un-rotating filter). In this case, the configuration of the first discharge portion and the configuration of the suction nozzles may be appropriately modified.

In the embodiments, the compressed gas supply unit 60 is disposed so as to supply compressed gas to the secondary side of the filter 20. However, this is not a limitation. For example, the compressed gas supply unit may be disposed so as to supply compressed gas to the primary side of the filter. In this case, the communication line provides communication between the primary side and the secondary side of the filter 20 so that the compressed gas supplied from the compressed gas supply unit 60 to the primary side of the filter 20 can flow via the introduction portion 14 and the second discharge portion 131 toward the top of the secondary side of the filter 20, without flowing toward the discharge line L3.

In the embodiments, the ballast water is caused to flow from the inside of the cylindrical filter 20 toward the outside for ballast water filtering. However, this is not a limitation. For example, the ballast water may be caused to flow from the outside of the tubular filter to the inside thereof for filtering. In this case, the compressed gas supply unit may be configured to supply the compressed gas to the secondary side of the filter (inside the filter), or to the primary side of the filter (outside the filter).

In the second embodiment, communication is provided by the communication line L5 between the second discharge portion 131 and the introduction portion 14. However, this is not a limitation. Communication may be provided by the communication line L5 between the second discharge portion 131 and the introduction line L1. That is, the communication line L5 only need to provide communication between the primary side and the secondary side of the filter 20 so that the gas supplied from the second discharge portion 131 can flow to the primary side of the filter 20 in the casing 10 via the introduction portion 14 without flowing toward the discharge line L3, or so that the gas supplied from the introduction portion 14 can flow to the secondary side of the filter 20 in the casing 10 via the second discharge portion 131 without flowing toward the discharge line L3.

What is claimed is:

1. A ballast water treatment device comprising:
a casing;
a filter disposed in the casing to filter ballast water;
an introduction portion for introducing the ballast water to a primary side of the filter;
a first discharge portion in the casing for discharging the ballast water from the primary side of the filter; and
a second discharge portion disposed at a lower portion of the casing at a secondary side of the filter to discharge the ballast water from the secondary side of the filter.

2. The ballast water treatment device according to claim 1, further comprising a communication unit providing communication between the primary side and the secondary side of the filter.

3. The ballast water treatment device according to claim 2, wherein the communication unit connects the second discharge portion and the introduction portion.

4. The ballast water treatment device according to claim 1, further comprising a compressed gas supply unit for supplying compressed gas into the casing.

5. The ballast water treatment device according to claim 3, further comprising a compressed gas supply unit for supplying compressed gas into the casing.

6. The ballast water treatment device according to claim 5, wherein the compressed gas supply unit supplies the compressed gas between the filter and the casing.

7. The ballast water treatment device according to claim 3, wherein the introduction portion has a cross sectional flow passageway area greater than a cross sectional flow passageway area of the first discharge portion.

8. The ballast water treatment device according to claim 4, wherein the introduction portion has a cross sectional flow passageway area greater than a cross sectional flow passageway area of the first discharge portion.

9. The ballast water treatment device according to claim 5, wherein the introduction portion has a cross sectional flow passageway area greater than a cross sectional flow passageway area of the first discharge portion.

10. The ballast water treatment device according to claim 1, further comprising an introduction line connected to the introduction portion to supply the ballast water to be filtered into the casing, wherein
the first discharge portion includes a discharge line for discharging the ballast water in the casing, with one end of the discharge line being connected to the introduction line or the introduction portion.
